(19) United States
(12) Patent Application Publication
(10) Pub. No.: US 2003/0008199 A1
(43) Pub. Date: Jan. 9, 2003

(54) Class of electrocatalysts and a gas diffusion electrode based thereon

(75) Inventors: Gennadi Finkelshtain, Givatada (IL); Yuri Katsman, Hadera (IL); Gregory Borover, Gushetzion (IL)

Correspondence Address: DR. MARK FRIEDMAN LTD., c/o Bill Polkinghorn, Discovery Dispatch, 9003 Florin Way, Upper Marlboro, MD, 20772, US

(73) Assignee: MEDIS EL LTD.

(21) Appl. No.: 10/229,055

(22) Filed: Aug. 28, 2002

Related U.S. Application Data
(63) Continuation of application No. 09/503,592, filed on Feb. 14, 2000.
Application No. 09/503,592 is a continuation-in-part of application No. 09/377,749, filed on Aug. 20, 1999, now Pat. No. 6,380,126.

(51) Int. Cl. H01M 4/90; H01M 8/08

(52) U.S. Cl. 429/43; 429/46; 429/42; 429/13

(57) ABSTRACT

An electrocatalyst based on a highly electroconducting polymer and a transition metal, in which transition metal atoms are covalently bonded to heteroatoms of the backbone monomers of the polymer. The covalently bonded transition metal atoms are nucleation sites for catalytically active transition metal particles. The complex is prepared by complexing a highly electroconducting polymer with transition metal coordination ions and then reducing the transition metal ions to neutral atoms. An electrode for a fuel cell is made by impregnating an electrically conducting sheet with the catalytic complex and drying the impregnated sheet. A fuel cell with a liquid anolyte uses the electrode as its cathode. The anolyte includes an aqueous solution of conjugate polybasic acids buffer, such as H₃PO₄—NaH₂PO₄—Na₂HPO₄, and an alcohol such as methanol as a reductant.

This is a continuation of U.S. patent application Ser. No. 09/503,592, filed Feb. 14, 2000, which is a continuation in part of U.S. patent application Ser. No. 09/377,749 filed Aug. 20, 1999, now U.S. Pat. No. 6,380,126, issued Apr. 30, 2002.

### FIELD AND BACKGROUND OF THE INVENTION

The present invention relates to electrochemistry and, more particularly, to a new class of electrocatalysts based on highly electroconducting polymers that lave transition metal atoms covalently bonded to backbone heteroatoms, to a gas diffusion electrode including such electrocatalysts, and to a fuel cell based on such an electrode and on an innovative electrolyte.

Like all electrochemical cells used to produce electricity, a fuel cell consists of an electrolyte sandwiched between two electrodes, a cathode and an anode. The transport of electrical charge from one electrode to another across the electrolyte allows the oxidation of a reductant at the anode and the reduction of an oxidant at the cathode without direct contact of the two reactants. The difference between a fuel cells and other such electrochemical cells is that in a fuel cell, the reactants are continuously replenished. For example, in a fuel cell that combines hydrogen gas with oxygen gas to produce electricity, the hydrogen is oxidized to H⁺ at the anode, the oxygen is reduced to O⁻² at the cathode, the ions diffuse into the electrolyte and combine to form water, and the water diffuses out of the electrolyte.

One obvious requirement in a hydrogen-oxygen fuel cell is that the gaseous reactants must be able to diffuse into the electrodes. For this reason, these electrodes are called “gas diffusion electrodes”. FIG. 1 is a sketch of a prior art gas diffusion electrode 10, in cross-section. Bonded to a surface 14 of a porous, electrically conductive support sheet 12 are many small (typically colloidal) catalytically active particles 16. The function of catalytically active particles 16 is to catalyze the anode and cathode reactions, and to conduct the electrons produced (anode) or consumed (cathode) by the reactions to (anode) or from (cathode) sheet 12. Common examples of sheet 12 include carbon paper and carbon cloth; but metal (nickel or steel) mesh sheets 12 also are known. The charge carriers of sheet 12 usually are electrons, but sheets 12 in which the charge carriers are protons also are known. Typically, catalytically active particles 16 consist of cores of activated carbon, on the surfaces of which are deposited yet smaller particles of a catalytically active transition metal such as platinum. Surface 14 is the side of electrode 10 that faces the electrolyte in a fuel cell. Particles 16 typically are embedded in a layer 18 of a hydrophobic polymer such as polytetrafluoroethylene (PTFE). The function of hydrophobic layer 18 is to repel water that is formed during the process of electrocatalysts.

Various methods are known for fabricating electrode 10. These methods are reviewed by Frost et al. in U.S. Pat. No. 5,702,839, which is incorporated by reference for all purposes as if fully set forth herein. One such method which is reviewed by Frost et al., and which includes screen printing of a co-suspension of carbon particles and particles of a hydrophobic polymer onto sheet 12, is taught by Goller et al. in U.S. Pat. No. 4,185.131, which also is incorporated by reference for all purposes as if fully set forth herein. Frost et al. then go on to teach their own method for fabricating electrode 10.

One field in which fuel cells have yet to realize their potential advantages of low cost and low pollution is that of automotive propulsion.

Internal combustion engines, in comparison with other types of engine technology such as electrical engines and engines powered by fuel cells, consume the greatest amount of fuel and also release the greatest amount of pollutants. Moreover, internal combustion engines operating on the Otto cycle have an operating efficiency of at most only 32%, while internal combustion engines operating on the Diesel cycle have an operating efficiency of at most only 40%.

Considerable effort has been expended by corporations, universities, government institutions and private individuals on finding a realistic commercial alternative to the internal combustion engine. Ideally, automobiles with such an alternative power source must be no more expensive to build and operate than vehicles with internal combustion engines. Moreover, the production of pollutants must be reduced, if not eliminated, relative to the internal combustion engine. Alternatives include electrical engines utilizing battery power, electrical engines tapping solar energy, methane gas engines and fuel cell engines. These alternatives is also have been combined with internal combustion engines in hybrid vehicles. So far, no practical solution has been attained.

Fuel cells have emerged in the last decade as one of the most promising new technologies for meeting global electric power needs well into the twenty-first century. Fuel cells are inherently clean and remarkably efficient, and have been shown by the U.S. Department of Energy's Federal energy Technology Center and its industrial partners to supply electricity reliably while reducing emissions of carbon dioxide by 40 to 60 percent. Fuel cells produce negligible harmful emissions and operate so quietly that they can be used in residential neighborhoods.

Nevertheless, fuel cells have not yet provided a viable solution in the automotive field. Generally, engines using fuel cells have been too expensive to manufacture.

One important class of fuel cell is the proton exchange membrane (PEM) fuel cell, in which the electrolyte is a proton exchange membrane made of a material such as a PTFE-based ionomer such as Nafion®, available from E. I. DuPont de Namours and Company, Wilmington Del. Fuel cells of this class have much higher output power densities than fuel cells of competing classes, such as phosphoric acid liquid electrolyte fuel cells. Therefore, although PEM fuel cells operate only at relatively low temperatures, up to at most about 120° C. (vs., for example, up to 210° C. in the case of phosphoric acid liquid electrolyte fuel cells), PEM fuel cells show great promise for use in residential and small vehicle settings.

Other disadvantages of PEM fuel cells include the following:

1. The most efficient catalytic particles are platinum particles. Platinum is relatively costly.

2. Hydrogen gas for domestic use typically is produced by the reforming of natural gas. One by product of this reforming is carbon monoxide, which poisons platinum catalysts.

3. The efficiency of the cell depends on good electrical contact between particles 16 and sheet 12. This contact tends to be degraded over time, as a consequence of the gradual poisoning of the catalyst, and also as a consequence of environmental insults such as vibration.

Another important class of fuel cell is the liquid fuel cell, i.e., a fuel cell whose reductant (fuel) is a liquid, particularly an alcohol such as methanol. A methanol-air fuel cell using a neutral or slightly acidic liquid electrolyte has been a leading candidate for the production of electrical energy, because alcohols such as methanol are easy to produce by fermentation or by liquefaction of coal. Typically, the methanol fuel is mixed with the electrolyte to form an “anolyte”. The methanol reacts with water at the anode to produce carbon dioxide and hydrogen ions. The hydrogen ions diffuse to the cathode, where they react with atmospheric oxygen to produce water.

In all fuel cells that use liquid anolytes, the composition of the anolyte is an important design consideration. The anolyte should have both high electrical conductivity and high ionic mobility at the optimal fuel concentration. Acidic solutions are most commonly used. Unfortunately, these acidic solutions need relatively high reaction temperatures (as in the case of phosphoric acid), at which temperatures these solutions tend to passivate or even destroy the anodes. Anolytes with pHs close to 7 are more anode-friendly but have insufficient electrical conductivity. Consequently, almost all prior art direct methanol fuel cells are based on solid polymer electrolyte (SPE) membranes. Fuel cells based on SPE membranes have other advantages over fuel cells based on liquid anolytes, including higher ultimate power densities and longer operating lifetimes. The disadvantages of SPE membrane fuel cells, relative to liquid electrolyte fuel cells, include necessarily complicated fuel feeding systems and very low methanol concentrations in the membranes. These disadvantages make the miniaturization of SPE membrane fuel cells almost impossible.

Highly electroconducting polymers (HECP) are a class of polymers whose electrical resistivities are comparable to the resistivities of metals, in the range 0.1 to 100 siemens/cm. Typical examples of HECPs include polyaniline, polypyrrole, polythiophene and polyfuran. These HECPs include heteroatoms (N, N, S and O respectively) in their backbone monomers. Rajeshwar et al., in U.S. Pat. No. 5,334,292, , which is incorporated by reference for all purposes as if fully set forth herein, teach an improved electrode 10 in which particles 16 and layer 18 are replaced by a layer of a HECP polymer within which catalytically active colloidal particles, for example, platinum particles as small as 10 nanometers across, are dispersed uniformly. This electrode has the following advantages over electrode 10:

1. The three-dimensional disposition of the catalytically active particles in the electrode of Rajeshwar et al. gives that electrode higher catalytic activity per unit volume, hence per unit weight, than electrode 10, in which particles 16 are distributed two-dimensionally along surface 14.

2. This increased specific catalytic activity allows the use of a smaller amount of costly catalytic materials such as platinum in the electrode of Raheshwar et al, than in electrode 10.

3. That the catalytically active particles of Rajeshwar et al. are embedded in an electrically conductive medium (the HECP), which in turn is in contact with surface 14 all along surface 14, provides the catalytically active particles of Rajeshwar et al. with a much better electrical contact to sheet 12 than particles 16 have to sheet 12 in electrode 10.

4. The embedding of the catalytically active particles of Rajeshwar et al. in a polymer matrix also provides the electrode of Rajeshwar et al. with better mechanical stability, in terms of resistance to disruption by impact and vibration, than electrode 10.

5. It is believed that the HECP matrix provides resistance to carbon monoxide poisoning of colloidal platinum particles.

### SUMMARY OF THE INVENTION

According to the present invention there is provided a heterogeneous catalyst including: (a) a highly electroconducting polymer having at least one heteroatom per backbone monomer unit thereof and a plurality of transition metal atoms covalently bonded to at least a portion of the heteroatoms.

According to the present invention there is provided a method of preparing a catalyst, including the steps of: (a) complexing a highly electroconducting polymer with a plurality of transition metal coordination complexes to produce a polymer-transition metal complex; and (b) reducing the polymer-transition metal complex to place the transition metal in a neutral oxidation state.

According to the present invention there is provided an electrode including: (a) an electrically conducting sheet; and (b) a catalytic polymer film, bonded to one side of the sheet, the catalytic polymer film including a highly electroconducting polymer having at least one heteroatom per backbone monomer unit thereof and a plurality of transition metal atoms covalently bonded to at least a portion of the heteroatoms.

According to the present invention there is provided a fuel cell including: (a) an anode; (b) a cathode; (c) an electrolyte sandwiched between the anode and the cathode; with at least one electrode, selected from the group consisting of the anode and the cathode, including: (i) an electrically conducting sheet and (ii) a catalytic polymer film, bonded to a side of the sheet that faces the electrolyte, the catalytic polymer film including a highly electroconducting polymer having at least one heteroatom per backbone monomer unit thereof and a plurality of transition metal atoms covalently bonded to at least a portion of the heteroatoms.

According to the present invention there is provided a method for producing an electrode, including the steps of: (a) complexing a highly electroconducting polymer with a plurality of transition metal coordination complexes to produce a polymer-transition metal complex: (b) reducing the polymer-transition metal complex to place the transition metal in a neutral oxidation state; (c) dispersing the reduced polymer-transition metal complex in a solvent; and (d) impregnating an electrically conducting sheet with the dispersion.

According to the present invention there is provided a fuel cell, including: (a) an anode; (b) a cathode; (c) a liquid electrolyte between the anode and the cathode; herein the cathode includes: (i) an electrically conducting sheet, and (ii) a catalytic polymer film, bonded to a side of the sheet that faces the electrolyte, the catalytic polymer film including a highly electroconducting polymer having at least one heteroatom per backbone monomer unit thereof and a plurality of transition metal atoms covalently bonded to at least a portion of the heteroatoms; and wherein the electrolyte includes an alcohol.

According to the present invention there is provided a fuel cell, including: (a) an anode; (b) a cathode including a plurality of catalytically active transition metal particles; and (c) a liquid electrolyte, between the anode and the cathode, the electrolyte including: (i) an alcohol, and (ii) an aqueous solution of at least two conjugate polybasic acids.

According to the present invention there is provided a method of producing electrical current, including the steps of: (a) providing a fuel cell including: (i) an anode, and (ii) a cathode including: (A) an electrically conducting sheet, and (B) a catalytic polymer film, bonded to a side of the sheet that faces the anode, the catalytic polymer film including a highly electroconducting polymer having at least one heteroatom per backbone monomer unit thereof and a plurality of transition metal atoms covalently bonded to at least a portion of the heteroatoms; (b) providing a liquid anolyte including an alcohol fuel; and (c) introducing the liquid anolyte into the fuel cell, between the anode and the cathode.

According to the present invention there is provided a method of producing electrical current, including the steps of: (a) providing a fuel cell including: (i) an anode, and (ii) a cathode including a plurality of catalytically active transition metal particles; (b) providing a liquid anolyte including: (i) an alcohol fuel, and (ii) an aqueous solution of at least two conjugate polybasic acids; and (iii) introducing the liquid anolyte into the fuel cell, between the anode and the cathode.

The present invention is based on an innovative electrode that is similar to the electrode of Rajeshwar et al., but has vet smaller catalytic particles, some possibly as small as single atoms of a transition metal, dispersed within a matrix of a HECP having heteroatoms in its backbone monomers. The preferred HECPs include polyaniline, polypyrrole, polythiophene and polyfuran. The preferred transition metals include platinum, iridium, osmium, rhenium, ruthenium, rhodium, palladium, iron, cobalt, nickel, chromium, manganese, copper and vanadium. The most preferred HECPs are polyaniline and polypyrrole. The most preferred transition metals are platinum and iridium. The transition metal catalytic particles are believed to be nucleated around single transition metal atoms that are covalently bonded to some of the backbone heteroatoms of the HECPs.

The HECP-transition metal complex of the present invention is prepared by complexing the HECP, preferably in a basic form, with coordination complexes of the transition metal, and then reducing the transition metal cations of the resulting HECP-transition metal coordination complex to a neutral oxidation state. Preferably, the reduction is effected by mixing the complex with an aqueous solution of a reductant such as sodium borohydride, formaldehyde and hydrazine.

The HECP-transition metal complex of the present invention, in and of itself, constitutes a catalyst having applications beyond its primary application as a component of a fuel cell electrode. Therefore, the HECP-transition metal complex of the present invention also is referred to herein as a “catalytic HECP complex”. For use in a PEM fuel cell electrode, the catalytic HECP complex of the present invention preferably includes a polytetrafluoroethylene (PTFE)-based ionomer. Optionally, the catalytically active transition metal particles of the present invention are supplemented by prior art catalytically active particles 16, deposited on surface 14 of sheet 12 by the methods of the prior art, for example, by screen-printing a paste of particles 16 onto surface 14. Following this deposition, sheet 12 is impregnated with a dispersion of the catalytic HECP complex of the present invention in a solvent, and is subsequently dried. Preferred solvents include xylene, chloroform, toluene and m-cresol, and the dispersion is stabilized by a stabilizer such as a sulfonic acid.

The electrode of the present invention also is an ideal cathode for a liquid anolyte fuel cell that uses an alcohol such as methanol as the reductant. Preferably, the alcohol constitutes between 10% and 45% of the anolyte by weight. The preferred electrolyte is an aqueous solution of at least two conjugate polybasic acids. Conjugate polybasic acids are acids that share a common anion. For example, the acids H₃PO₄, NaH₂PO₄ and Na₂HPO₄, share PO₄⁻³ as a common anion. Preferably, the more acidic acid or acids are present in stoichiometric excess over the least acidic acid, and the solution has a pH of at most 3.5. Such an electrolyte has relatively high electrical conductivity and relatively high ionic mobility, and supports a relatively high concentration of the alcohol reductant. The scope of the present invention includes fuel cells based on such anolytes and using, as their cathodes, not only the electrode of the present invention, but also any electrode based on catalytically active transition metal particles, for example, the electrode of Rajeshwar et al.

### BRIEF DESCRIPTION OF THE DRAWINGS

The invention is herein described, by way of example only, with reference to the accompanying drawings, wherein:

FIG. 1 shows a prior art gas diffusion electrode;

FIG. 2 shows three of the steps in the preparation of a polyaniline-platinum complex;

FIG. 3 is a schematic illustration of a PEM fuel cell of the present invention;

FIG. 4A is an x-ray photoelectron spectrum of polyaniline;

FIG. 4B is an x-ray photoelectron spectrum of a polyaniline-platinum complex;

FIG. 5 is an enlarged superposition of the nitrogen 1s lines of the spectra of FIGS. 4A and 4B;

FIG. 6A is an infrared spectrum of polyaniline;

FIG. 6B is an infrared spectrum of a polyaniline-platinum complex.

### DESCRIPTION OF THE PREFERRED EMBODIMENTS

The present invention is of a catalytic HECP complex that includes catalytically active transition metal particles nucleated around transition metal atoms covalently bound to backbone heteroatoms thereof. The present invention can be used as a component of an electrode in a PEM fuel cell and in a fuel cell that has a liquid anolyte. The scope of the present invention also includes an electrode that incorporates the catalytic HECP complex, a fuel cell that includes the electrode, and method of preparing the catalytic HECP complex and the electrode.

The principles and operation of a catalytic HECP complex and of a fuel cell based thereon according to the present invention may be better understood with reference to the drawings and the accompanying, description.

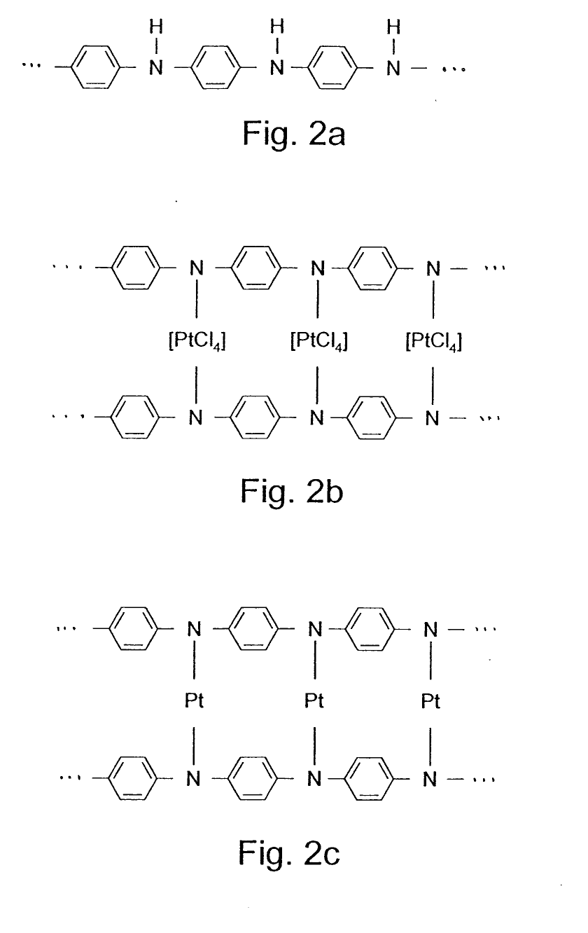

Referring again to the drawings, FIG. 2 shows three of the steps in the preparation of one of the most preferred embodiments of the catalytic HECP complex of the present invention, in which the HECP is polyaniline and the transition metal is platinum. FIG. 2A shows a polyaniline chain. FIG. 2B shows a complex of polyaniline with PtCl₄ coordination complexes. FIG. 2C shows the complex of FIG. 2B after reduction of the Pt⁺¹ of FIG. 2B to Pt⁰.

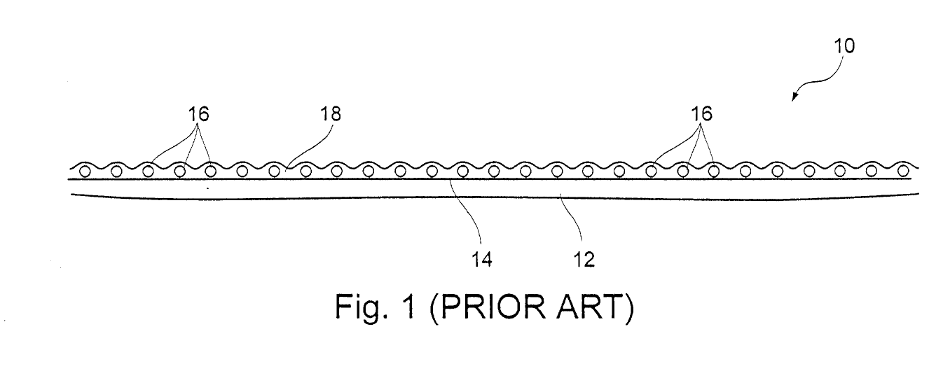

FIG. 1B of Rajeshwar et al. serves to illustrate, schematically, an electrode of the present invention. What Rajeshwar et al. label as a “microporous film” should be understood as the catalytic HECP complex of the present invention. The particles labeled “Catalyst” by Rajeshwar et al. are to be understood as the catalytically active transition metal particles of the present invention, not drawn to scale, as many the catalytically active particles of the present invention are believed to be only several atoms in size, or even as small as a single atom.

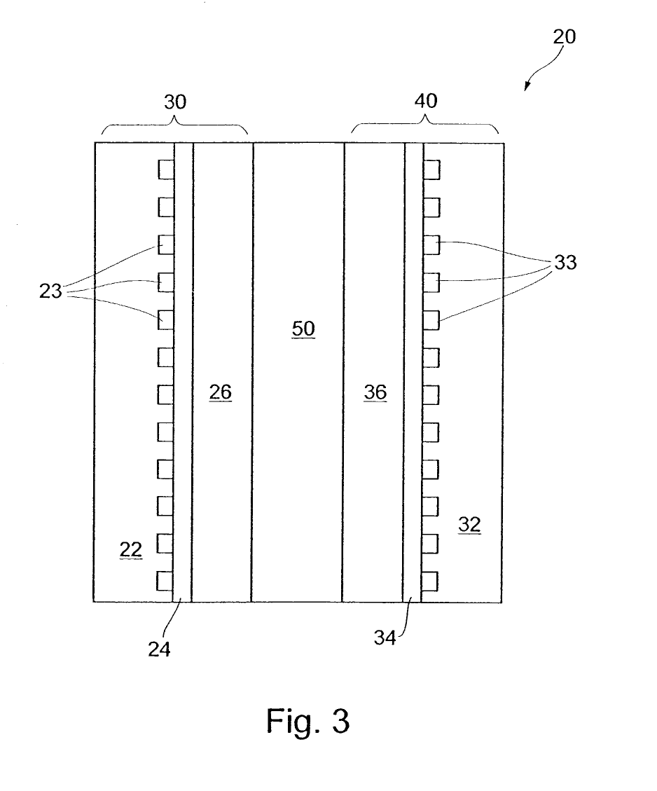

FIG. 3 shows, schematically, a PEM fuel cell 20 of the present invention. Fuel cell 20 consists of a PEM electrolyte 50 sandwiched between an anode 30 and a cathode 40. Anode 30 consists of a graphite plate 22 bearing a carbon sheet 24. The side of carbon sheet 24 that faces electrolyte 50 is covered by a layer of catalytic HECP complex 26. Similarly, cathode 40 consists of a graphite plate 32 bearing a carbon sheet 34. The side of carbon sheet 34 that faces electrolyte 50 is covered by a layer of catalytic HECP complex 36. The side of graphite plate 22 that bears carbon sheet 24 includes grooves 23 for admitting hydrogen gas. Similarly, the side of graphite plate 32 that bears carbon sheet 34 includes grooves 33 for admitting oxygen gas.

In the examples presented below the HECPs are polyaniline and polypyrrole. Polyaniline was prepared as described by X. Wei and A. Epstein, “Synthesis of highly sulfonated polyaniline”. Synthetic Metals, vol. 74 pp. 123-125 (1995). (NH₄)₂S₂O₈ was used as an oxidizer. Polypyrrole was prepared as described in T. H. Chao and J. March. “A study of polypyrrole synthesized with oxidative transition metal ions”. Journal of Polymer Science, Part A: Polymer Chemistry, vol. 26 pp. 743-753 (1988). FeCl₃ was used as an oxidizer.

The first four examples are of catalytic HECP complexes of the present invention. The last nine examples are of electrodes that incorporate the catalytic HECP complex of the present invention.

### EXAMPLE 1

5.12 g of polyaniline powder (in basic form) and 100 ml of distilled water were mixed if an Erlenmeyer flask for 30 minutes to prepare an aqueous suspension of polyaniline. 110 ml of 0.98% aqueous H₂PtCl₆ were slowly added to this suspension over the course of 60 minutes while stirring constantly. The resulting polyaniline-PtCl₄ complex was separated by centrifuging and decanting. The resulting solid filtrate was colorless, unlike the initial polyaniline suspension, which was yellow, showing that the H₂PtCl₆ had reacted with the polyaniline. The filtrate was rinsed with distilled water until the rinse water had a pH of 7.

A reductant solution was prepared by dissolving 1.5 g NaBH₄ and 0.7 g NaOH in 100 ml of distilled water at room temperature with stirring for 30 minutes. The polyaniline-PtCl₄ complex filtrate was placed in an Erlenmeyer flask, and the reductant solution was added dropwise while stirring over the course of 2 hours and heating gently, to no more than 60° C. The product of this reaction was rinsed with distilled water until the rinse water had a pH of 7, and then was dried at 110° C. for 24 hours.

### EXAMPLE 2

As in example 1, 4.73 g of polyaniline were suspended in 100 ml of distilled water. 80 ml of 1.15% aqueous H₂IrCl₆ were added slowly to the polyaniline suspension over the course of 60 minutes while stirring constantly. The resulting polyaniline-IrCl₄ complex was separated by centrifuging and decanting. The resulting solid seas rinsed with distilled water until the rinse water had a pH of 7.

The reductant solution of Example 1 was added to the polyaniline-IrC₄ complex over the course of 2 hours at a temperature of 60° C. The product of this reaction was rinsed Faith distilled water until the rinse water had a pH of 7, and then was dried at 110° C. for 24 hours.

### EXAMPLE 3

4.90 g of polypyrrole powder were suspended in 100 ml of distilled water. 105 ml of 0.98% aqueous H₂PtCl₆ were added to the polypyrrole suspension over the course of 60 minutes while stirring constantly. The resulting polypyrrole-PtCl₄ complex was separated by centrifuging and decanting. The resulting solid was rinsed with distilled water until the rinse water had a pH of 7.

The reductant solution of Example 1 was added to the polypyrrole-PtCl₄ complex at a temperature of 60° C. over the course of 2 hours. The product of this reaction was rinsed with distilled water until the rinse water had a pH of 7, and then was dried at 110° C. for 24 hours.

### EXAMPLE 4

As in example 3, 3.92 g of polypyrrole powder were suspended in 100 ml of distilled water. 70 ml of 1.15% aqueous H₂IrCl₆ were added to the polypyrrole suspension over the course of 60 minutes while stirring constantly. The resulting polypyrrole-IrCl₄, complex was separated by centrifuging and decanting The resulting solid was rinsed with distilled water until the rinse water had a pH of 7.

A reductant solution was prepared by dissolving 1.3 g NaBH₄ and 0.6 g NaOH in 100 ml of distilled water at room temperature with stirring for 30 minutes. This reductant solution was added to the polypyrrole-IrCl₄ complex over the course of 2 hours at a temperature of 60° C. The product of this reaction was rinsed with distilled water until the rinse water had a pH of 7, and then was dried at 110° C. for 24 hours

Table 1 shows the rate of oxygen gas liberation (cm³ per mg metal (Pt or Ir) per hour at room temperature and atmospheric pressure) from 20 ml of 10% H₂O₂ per gram of several catalysts: three prior art catalysts and the four catalysts of Examples 1-4.

TABLE 1

| catalyst | mass (g) | rate of O₂ release |
|---|---|---|
| 10% Pt/polypyrrole of Rajeshwar et al. | 0.16 | 0.7 |
| Polyaniline-Pt of Example 1 | 0.12 | 6.7 |
| Polyaniline-Ir of Example 2 | 0.15 | 2.2 |
| Polypyrrole-Pt of Example 3 | 0.15 | 17.3 |
| Polypyrrole-Ir of Example 4 | 0.16 | 3.1 |

In examples 5-11, suspensions of HECP-transition metal complexes were prepared by adding a stabilizer to the HECP-transition metal complex, along with sufficient organic solvent to produce a paste-like mixture. Electrodes 24 and 34 were fabricated on Toray® Teflon®-treated carbon sheets, available from Electrochem. Inc. of Woburn Mass. The paste-like mixture was applied to the sheets by screen printing, and the sheets were dried at 120° C. for 5 hours. The platinum content of the resulting impregnated sheets was 0.25 mg/cm². Circular discs 2.5 cm in diameter (4.9 cm² in area) were cut from the impregnated carbon sheets PEMs 3.5 cm in diameter, to serve as electrolyte 50, were cut from a Nafion®-117 sheet.

Membrane-electrode assemblies (MEAs) that emulate fuel cell 20 were fabricated as sandwich structures of PEMs between impregnated carbon sheets, sintered in a heated press tool by hot pressing. The MEAs were tested in a standard hydrogen—oxygen fuel cell. All tests were conducted at a constant gas pressure P_{H}_{₂} =P_{O}_{₂}=40 psig. Voltage-current curves of the MEAs were measured in the range 0.3 V to 0.8V.

As a control, example 12 used electrodes 24 and 34 prepared as taught by Rajeshwar et al., using colloidal platinum in polypyrrole.

Table 2 presents the results of examples 5-12. The current densities I are given for a voltage of 0.5 V.

TABLE 2

| | | | | I (amp/ |
|---|---|---|---|---|
| example | catalyst | solvent | stabilizer | cm²) |
| 5 | 2.94 g PPy-Pt complex | xylene | 0.29 g DBSA | 0.65 |
| 6 | 4.31 g PAni-Pt complex | xylene | 0.43 g DBSA | 0.98 |
| 7 | 2.40 g PAni-Pt complex | m-cresol | 0.24 g CSA | 0.84 |
| 8 | 4.37 g PAni-Pt complex | ethanol | 0.44 g Nafion | 1.22 |
| 9 | 5.05 g PPy-Pt complex | chloro- | 0.51 g DBSA | 0.60 |
| | | form | | |
| 10 | 4.52 g PPy-Pt complex | m-cresol | 0.45 g CSA | 0.56 |
| 11 | 3.94 g PAni-Pt complex | toluene | 0.40 g DBSA | 0.93 |
| 12 | 3.18 g PPy-Pt of | xylene | 0.32 g DBSA | 0.39 |
| | Rajeshwar et al. | | | |

Notes:
PAni = Polyaniline
PPy = Polypyrrole
DBSA = dodecylbenzenesulfonic acid
CSA = camphorsulfonic acid
Nafion = 5% ethanol solution of Nafion ®
p-toluenesulfonic acid also is suitable as a stabilizer.

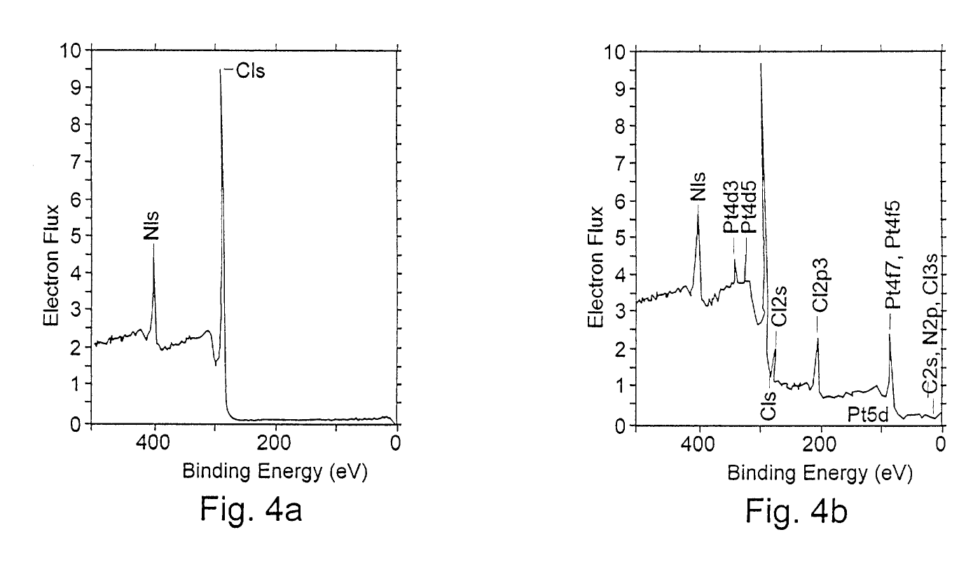

FIGS. 4-6 show measurements conducted on the polyaniline-platinum complex of example 1, and on a control sample of polyaniline, that demonstrate that that platinum is indeed covalently bonded to the polyaniline.

FIGS. 4A and 4B are x-ray photoelectron spectra of polyaniline and of the polyaniline-platinum complex of example 1, respectively. The spectra were recorded at the Wolfson Applied Materials Research Center of Tel Aviv. Israel, using a Scanning AES/XPS Multitechnique System of PHI, and interpreted according to J. F. Moulder. Handbook of X-ray Photoelectron Spectroscopy. Perkin-Elmer, 1992. The spectral lines are labeled by the atomic orbitals that are the sources of the photoelectrons. The ordinates are electron flux, in arbitrary units.

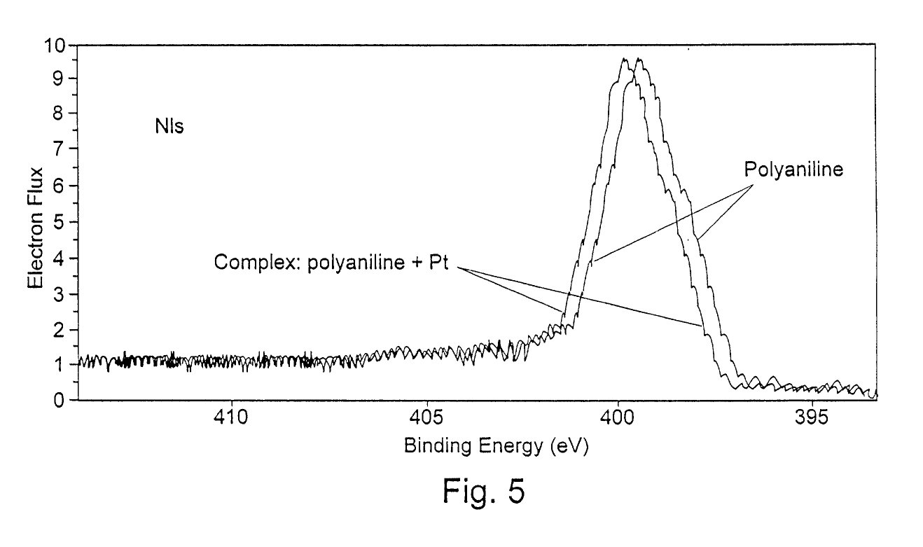

FIG. 5 is a horizontally expanded superposition of the nitrogen 1s lines of FIGS. 4A and 4B. The nitrogen 1s line of the polyaniline-platinum complex is shifted upward in binding energy relative to the nitrogen 1s line of polyaniline.

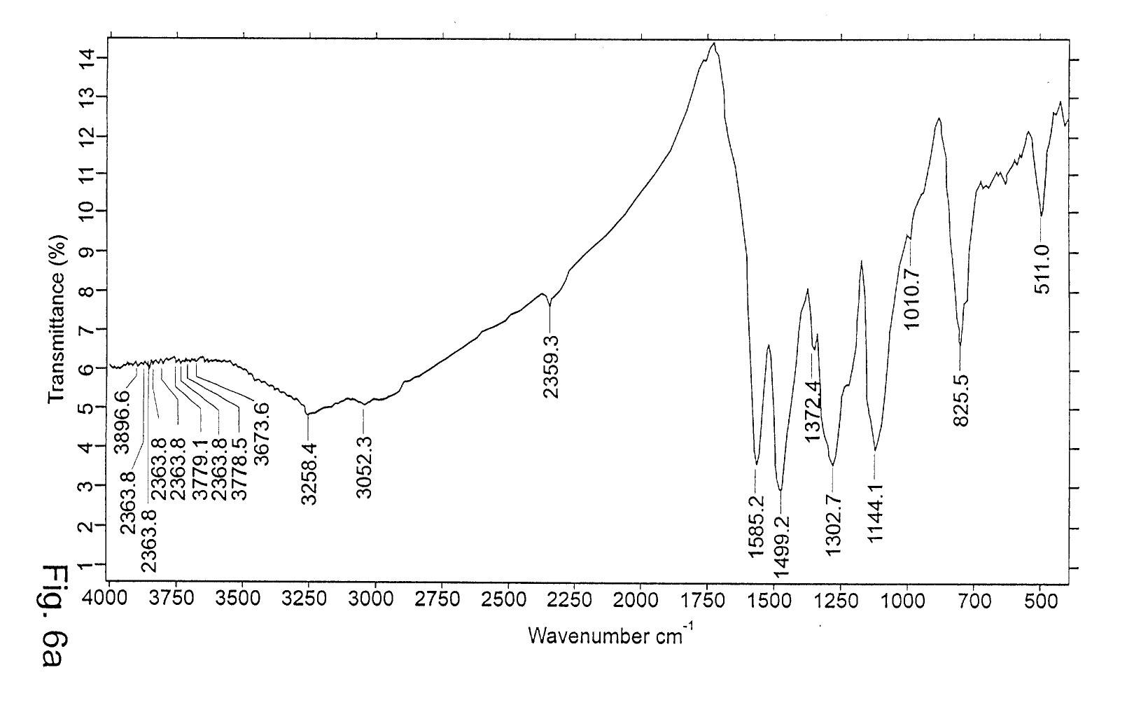

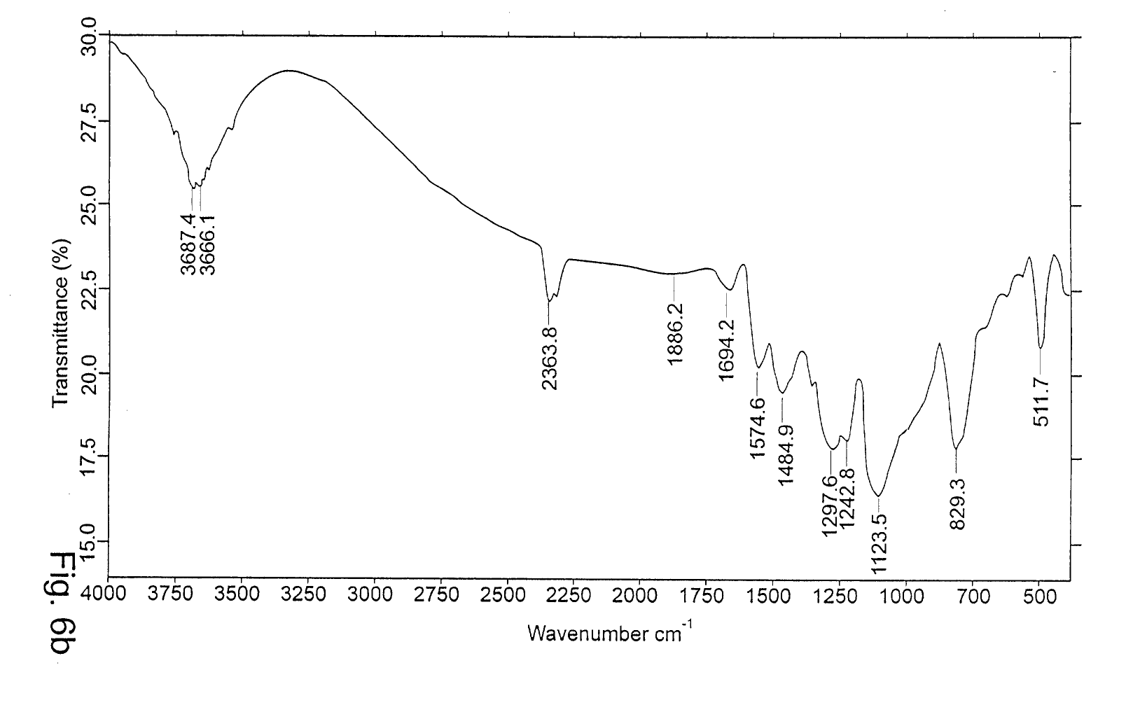

FIGS. 6A and 6B are infrared spectra of polyaniline and of the polyaniline-platinum complex of example 1, respectively. The spectra were recorded at the Chemistry Faculty of Tel Aviv University, Israel, using a Vector-22 IR spectrometer of Bruker Instruments, Inc., and interpreted according to Silverstein, Bassler and Morill, Spectrometric Identification of Organic Compounds. John Wiley and Sons. 1981. The spectral lines in FIGS. 6A and 6B belong to aromatic amines. The marked change in character between the two infrared spectra shows that the platinum of the polyaniline-platinum complex is indeed covalently bonded to the polyaniline.

FIG. 3 also serves to illustrate a liquid fuel cell 20 of the present invention. Reference numeral 50 now refers to a liquid, water-based anolyte including an alcohol such as methanol as the reductant. As before, anode 30 is illustrated as an electrically conducting (graphite or aluminum) plate 22 bearing a carbon sheet 24, with the side of carbon sheet 24 that faces anolyte 50 being covered by a layer of catalytic HECP complex 26. Similarly, cathode 40 is illustrated as a graphite plate 32 bearing a carbon sheet 34 whose side that faces anolyte 50 is covered by a layer of catalytic HECP complex 36. Alternatively, anode 30 and/or cathode 40 are any electrodes based on catalytically active transition metal particles, preferably also including carbon-supported catalytically active noble metal (Pt—Ru, Pt—Os, Pt—Pd, Pt—Rh or Pt—Re) particles. The oxidant is either pure oxygen or air, and the side of graphite plate 32 that bears carbon sheet 34 includes grooves 33 for admitting the gaseous oxidant. The alcohol reductant reacts with the water of the anolyte at anode 40 to produce CO₂ and H⁺. The CO₂ is vented via grooves 23 on the side of graphite plate 22 that bears carbon sheet 24. The H⁺ diffuses to cathode 40, where the H⁻ reacts with the oxidant to form water. A mechanism (not shown) is provided to exclude, from grooves 23, air that otherwise would oxidize the alcohol at anode 30. Most preferably, alcohol reductant is replenished by flossing anolyte 50 through fuel cell 20.

Preferably, anolyte 50 is an aqueous solution of at least two conjugate polybasic acids, having a pH of at most 3.5 and having a stoichiometric excess of the more acidic acids over the least acidic acid. Most preferably, anolyte 50 is an aqueous solution of NaH₂PO₄ and Na₂HPO₄, with a stoichiometric excess of NaH₂HPO₄ over Na₂HPO₄ and with sufficient H₃PO₄ added to bring the pH to the desired value below 3.5. Preferably, the reductant is methanol, constituting between 10% and 45% of anolyte 50 by weight.

### EXAMPLE 13

Recrystallized NaH₂PO₄ and Na₂HPO₄ and twice-distilled deionized water were used to prepare 0.2M solutions that were mixed in the proportion 7.5 parts 0.2M NaH₂PO₄ to one part 0.2M Na₂HPO₄. Sufficient H₃PO₄ was added to bring the pH to 3.1. To 500 ml of this solution was added enough methanol to produce an anolyte containing 30% methanol by weight.

The cathode and the anode both were HECP-transition-metal-complex electrodes of the present invention, the cathode was prepared as in Example 8 above. This electrode included 20% by weight of Pt on a carbon sheet. The anode was prepared as in example 6 above, except that a 2:1 mixture of Pt to Ru was substituted for the Pt. This electrode included 20% by weight of Pt and 10% by weight of Ru on a carbon sheet. The carbon sheet of the anode was mounted on a 1 mm thick aluminum plate. Both electrodes were 0.96 cm² disks, separated by a gap of 6.5 mm.

The anolyte was introduced to the gap between the electrodes. The fuel cell produced electrical current at a power density of between 25 and 30 mW/cm² for several hours.

While the invention has been described with respect to a limited number of embodiments, it will be appreciated that many variations, modifications and other applications of the invention may be made.

What is claimed is:

1. A fuel cell, comprising:
(a) an anode:
(b) a cathode;
(c) a liquid electrolyte between said anode and said cathode;
wherein said cathode includes:
(i) an electrically conducting sheet, and
(ii) a catalytic polymer film, bonded to a side of said sheet that faces said electrolyte, said catalytic polymer film including a highly electroconducting polymer having at least one heteroatom per backbone monomer unit thereof and a plurality of transition metal atoms covalently bonded to at least a portion of said heteroatoms:
and wherein said electrolyte includes an alcohol.

2. The fuel cell of claim 1, wherein said alcohol is methanol.

3. The fuel cell of claim 2, wherein said alcohol is between about 10% and about 45% of said electrolyte by weight.

4. The fuel cell of claim 1, wherein said electrolyte includes an aqueous solution of at least two conjugate polybasic acids.

5. The fuel cell of claim 4, wherein said aqueous solution has a pH of at most about 3.5.

6. The fuel cell of claim 4, wherein said at least two conjugate polybasic acids include at least two acids selected from among H₃PO₄, NaH₂PO₄ and Na₂HPO₄.

7. The fuel cell of claim 6, wherein said at least two acids include said NaH₂PO₄ and said Na₂HPO_{4, and wherein said NaH}₂PO₄ is in stoichiometric excess over said Na₂HPO₄.

8. The fuel cell of claim 1, wherein said polymer film includes a polytetrafluoroethylene-based ionomer.

9. The fuel cell of claim 1, wherein said cathode further includes:
(iii) a plurality of catalytically active particles embedded in said film.

10. A fuel cell, comprising:
(a) an anode:
(b) a cathode including a plurality of catalytically active transition metal particles; and
(c) a liquid electrolyte, between said anode and said cathode, said electrolyte including:
(i) an alcohol, and
(ii) an aqueous solution of at least two conjugate polybasic acids.

11. The fuel cell of claim 10, wherein said transition metal particles are noble metal particles.

12. The fuel cell of claim 11, wherein said cathode includes:
(i) an electrically conducting sheet; and
(ii) a catalytic polymer film, bonded to a side of said sheet that faces said electrolyte, said catalytic polymer film including a highly electroconducting polymer having at least one heteroatom per backbone monomer unit thereof, at least some of said transition metal particles including a transition metal atom covalently bonded to one of said heteroatoms.

13. The fuel cell of claim 12 wherein said polymer film includes a polytetrafluoroethylene-based ionomer.

14. The fuel cell of claim 10, wherein said alcohol is methanol.

15. The feel cell of claim 14, wherein said alcohol is between about 10% and about 45% of said electrolyte by weight.

16. The fuel cell of claim 10, wherein said aqueous solution has a pH of at most about 3.5.

17. The fuel cell of claim 10, wherein said at least two conjugate polybasic acids include at least two acids selected from among H₃PO₄, NaH₂PO₄ and Na₂HPO₄.

18. The fuel cell of claim 17, wherein said at least two acids include said NaH₂PO₄ and said Na₂HPO₄, and wherein said NaH₂PO₄ is in stoichiometric excess over said Na₂HPO₄.

19. A method of producing electrical current, comprising the steps of:
(a) providing a fuel cell including:
(i) an anode, and
(ii) a cathode including:
(A) an electrically conducting sheet, and
(B) a catalytic polymer film, bonded to a side of said sheet that faces said anode, said catalytic polymer film including a highly electroconducting polymer having at least one heteroatom per backbone monomer unit thereof and a plurality of transition metal atoms covalently bonded to at least a portion of said
(b) providing a liquid anolyte including an alcohol fuel; and
(c) introducing said liquid anolyte into said fuel cell, between said anode and said cathode.

20. A method of producing electrical current, comprising the steps of:
(a) providing a fuel cell including:
(i) an anode, and
(ii) a cathode including a plurality of catalytically active transition metal particles;
(b) providing a liquid anolyte including:
(i) an alcohol fuel, and
(ii) an aqueous solution of at least two conjugate polybasic acids; and
(iii) introducing said liquid anolyte into said fuel cell, between said anode and said cathode.
